(19) United States
(12) Patent Application Publication
(10) Pub. No.: US 2010/0154287 A1
(43) Pub. Date: Jun. 24, 2010

(54) SNAKE TRAP SYSTEM

(76) Inventor: Stephen D. Irons, Stockton, MO (US)

Correspondence Address: WOOD AND EISENBERG, PLLC, 3975 University Drive, SUITE 330, Fairfax, VA, 22030, US

(21) Appl. No.: 12/411,121

(22) Filed: Mar. 25, 2009

Related U.S. Application Data
(60) Provisional application No. 61/139,806, filed on Dec. 22, 2008.

(51) Int. Cl. A01M 23/22; A01M 23/00

(52) U.S. Cl. 43/62

(57) ABSTRACT

A snake trap system includes a snake trap apparatus having a top portion and a bottom portion, a trigger, a guide member to guide falling motion of the top portion, a live bait trap, and a cover for covering the live bait trap when the top portion falls. The system includes a live bait catching trap, and a transporter for transporting the live bait between the live bait catching trap and the snake trap apparatus.

### CROSS REFERENCE TO RELATED APPLICATIONS

This application claims priority of provisional patent application No. 61/139,806 to Stephen D. Irons, filed on Dec. 22, 2008, entitled Snake Trap System. Application No. 61/139,806 is herein incorporated by reference in its entirety.

### STATEMENT REGARDING FEDERALLY SPONSORED RESEARCH OR DEVELOPMENT

Not applicable.

### FIELD OF THE INVENTION

The present invention relates generally to a system and apparatus for trapping snakes. More particularly, this invention is directed to an apparatus or device for safely trapping snakes using live bait.

### BACKGROUND OF THE INVENTION

As noted in U.S. Pat. No. 6,023,878, a snake trap has a housing which includes an entrance for snakes. A triggerable trap door closure is provided.

In U.S. Pat. No. 7,051,472, an animal trap is shown having a primary trap with sliding doors, a sensor, and battery. A release trap is also provided.

There is a need for an apparatus or system for safely trapping snakes, which is portable and needs no power source. Further, there is a need for an apparatus or system for safely trapping snakes, which includes use of live bait and which is relatively simple in construction.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an apparatus or system for catching snakes which is portable, needs no power source, and is relatively simple in construction.

The device according to the present invention includes a snake trap apparatus having a top portion and a bottom portion, a trigger, a guide member to guide falling motion of the top portion, a live bait trap, and a cover for covering the live bait trap when the top portion falls. The system includes a live bait catching trap, and a transporter for holding the live bait and also for transporting the live bait to a central portion of the snake trap apparatus.

Other objects and advantages of the present invention will be more readily apparent from the following detailed description when read in conjunction with the accompanying drawings.

### BRIEF DESCRIPTION OF THE DRAWINGS

FIG. 1 is top elevational view of a lower trap portion for a snake trap system, according to the present invention.

FIG. 2 is an enlarged view of a portion of FIG. 1 showing a trip member, according to the present invention.

FIG. 3 is a bottom elevational view of the lower trap portion of FIG. 1.

FIG. 4 is a side elevational view of the lower trap portion of FIG. 1.

FIG. 5 is side elevational view of a live bait transporter used in the snake trap system of the present invention.

FIG. 6 is a side elevational view of the live bait transporter of FIG. 5, as viewed from the right of FIG. 5.

FIG. 7 is bottom elevational view of the live bait transporter of FIG. 5.

FIG. 8 is a perspective view of the live bait transporter disposed on the lower trap portion.

FIG. 9 is a bottom elevational view of an upper trap portion used in the snake trap system of the present invention.

FIG. 10 is a side elevational view of the upper trap portion used in the snake trap system of the present invention, in a raised position showing a lower portion of an enclosure member.

FIGS. 11A and 11B are side elevational views of the upper trap portion of FIG. 10, showing an opening in the side wall.

FIG. 11C shows a removeable cover in relation to an opening in the side wall.

FIG. 12 is a view of the upper trap portion of FIG. 11, as viewed from the right of FIG. 11.

FIG. 13 is an enlarged view of the trip mechanism on the lower trap portion.

FIG. 14 is a schematic side view, partly in section, schematically showing the elements of the trip mechanism of FIG. 13.

FIG. 15 is a side elevational view of a snake removal basket for the system of the present invention.

FIG. 16 is a side elevational view of the snake removal basket of FIG. 15, as seen from the left of FIG. 15.

FIG. 17 is a top elevational view of the snake removal basket of FIG. 15.

FIG. 18 is an enlarged side elevational view of a door portion of the snake removal basket of FIG. 15, showing a door operating member.

FIG. 19 is a perspective view of the snake trap assembled in an operating position.

FIG. 20 is a schematic view of the operation of the snake trap of FIG. 19.

FIG. 21 is a schematic sectional view of the enclosure member in a closed position of the trap, in an enclosing position over the live bait transporter.

FIGS. 22A and 22B show views of a slidable clamp portion of the snake trap system, according to the present invention.

### DETAILED DESCRIPTION OF THE INVENTION

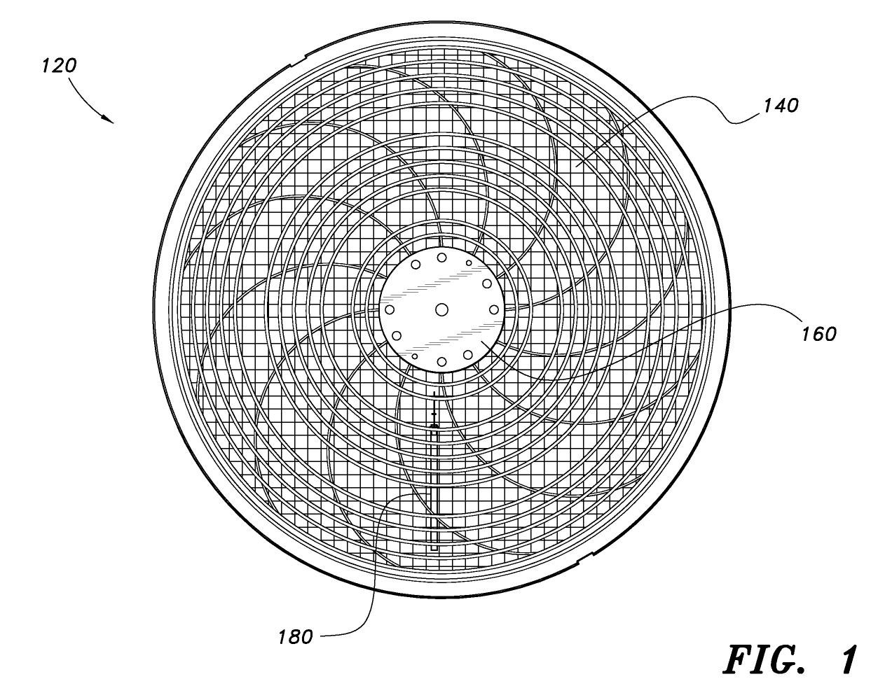

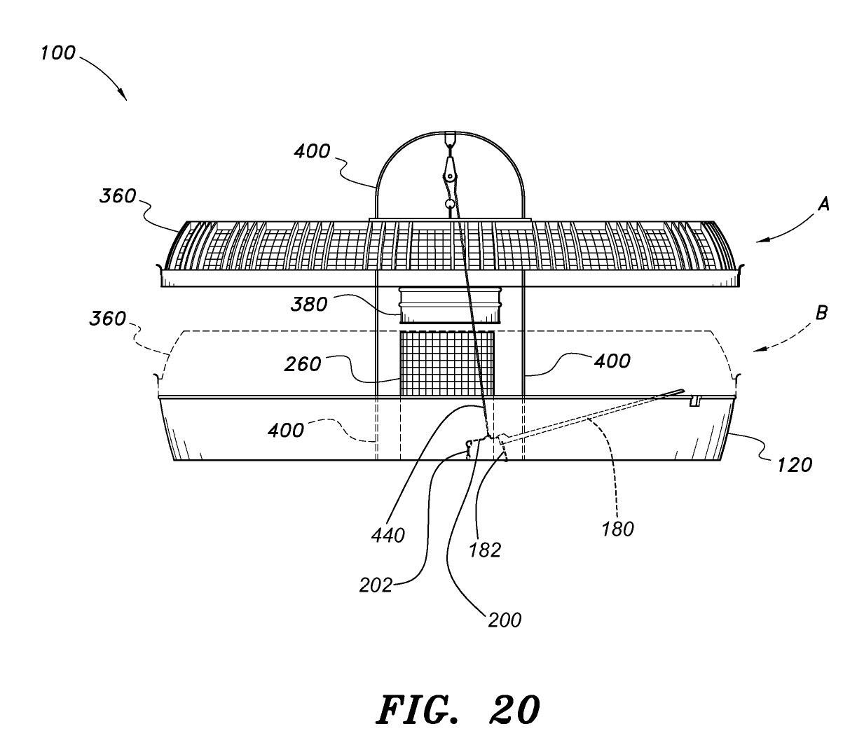

FIG. 20 is a simplified schematic view of the operation of a snake trap system 100. In this view, an upper trap portion 360 is disposed over a lower trap portion 120, in an operational position “A” in which the snake trap system 100 is in an “open” position for trapping a snake. This view also shows the upper trap portion 360 in dashed outline in a closed position “B” which traps the snake. FIG. 20 additionally shows a guide member 400, which guides movement of the upper trap portion 360 during motion between the “A” and “B” positions. An enclosure member 380 is shown attached to the upper trap portion 360, and a live bait transporter 260 is shown disposed on the lower trap portion 120. Details of the snake trap system 100 are shown and described in greater detail below with regard to FIGS. 1-19 and 21-22B.

FIG. 1 is a top elevational view of the lower trap portion 120 for the snake trap system 100. As seen here, the lower trap portion 120 has a rigid grating 140 and a central base 160. The central base 160 supports the live bait transporter 260 and also provides a fixed support for the guide member 400.

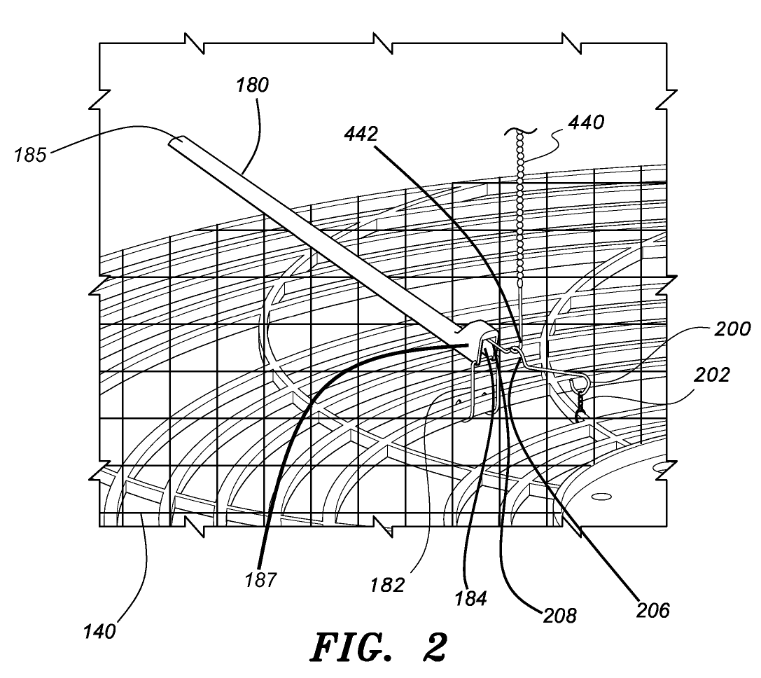

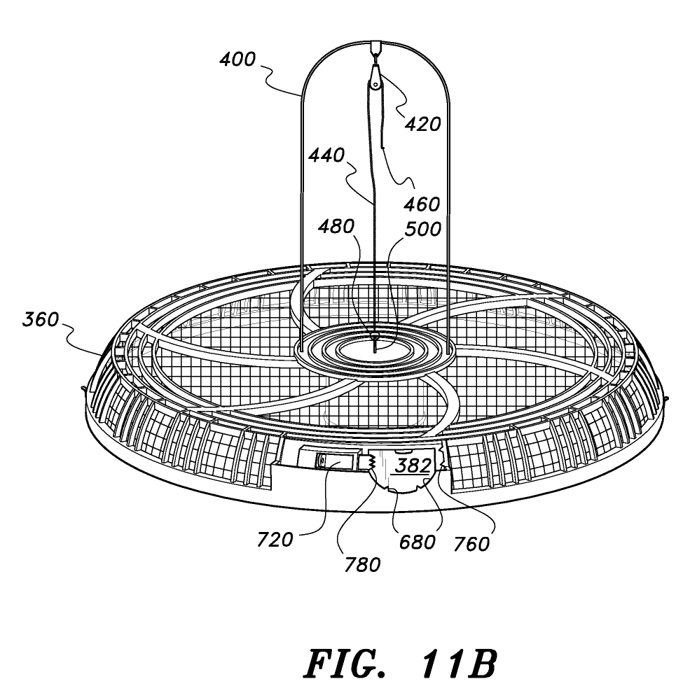

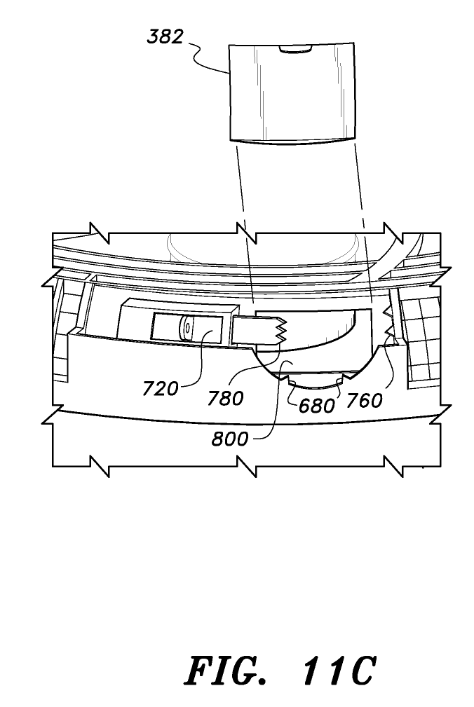

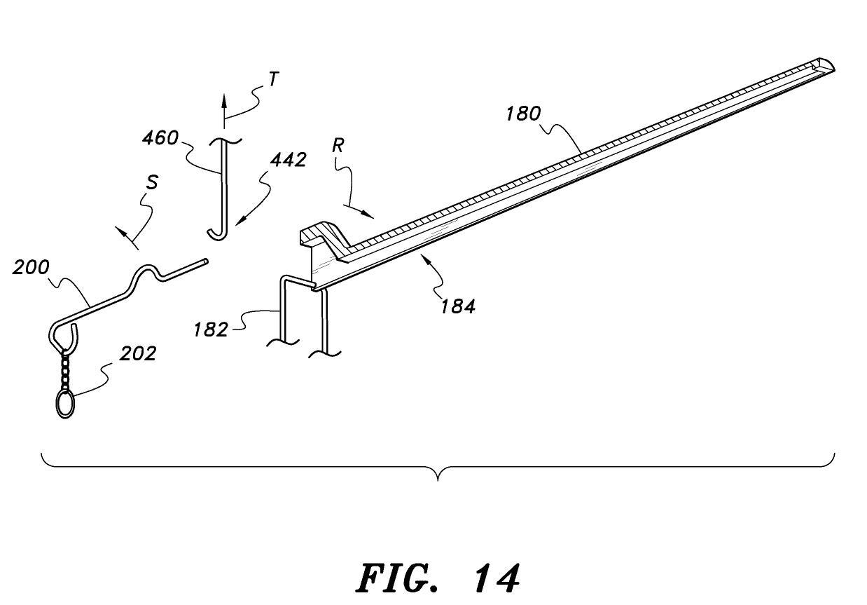

FIG. 2 is an enlarged view of a portion of FIG. 1 showing a trip member 180 and a hook 200. The trip member 180 has opposite ends; specifically a distal free end 185 and an opposite end 187. The opposite end 187 of the trip member 180 is anchored to the lower trap portion 120 by a U-shaped member 182 (see FIG. 20), such that the trip member 180 is pivotable about the U-shaped member 182. One end of the trip member 180 adjacent to the lowermost portion thereof (and also adjacent to the U-shaped member) has a hollow channel portion 184 (see FIG. 14). The hook 200 is anchored at one end by a chain segment 202 to the lower trap portion 120, and a middle portion of the hook 200 is supported by a chain 440, which exerts an upward force (discussed in further detail hereunder with regard to FIG. 11).

The lowermost end 442 of chain 440 is formed into a hook 460. The lowermost end 442 is attached slideably along the hook 200, and is disposed at a central curve 206 formed in the hook 200 in FIG. 2. The free end of the hook 200 is secured by frictional engagement within the hollow channel portion 184 of the trip member 180.

In operation, the trip member 180 is set as shown in FIG. 2, such that downward pressure on the distal free end (at the left of FIG. 2) causes pivoting rotation of the trip member 180 about the U-shaped member 182, which frees the frictionally-engaged end of the hook 200 from the hollow channel portion 184 of the trip member 180. The upward force exerted by the chain 440 on the hook 200 causes it to move upward, freeing the hook 200 and enabling the lower hooked end 442 of the chain 440 to slide along the hook 200 until the hooked end 442 is completely free of the hook 200. Since the upper trap portion 360 is held up by the weight of the chain 440, the release of the chain 440 results in falling of the upper trap portion from the open position “A” to the closed position “B”.

When the trip member 180 is horizontally oriented, it takes the least amount of force to release the hook 200 and thereby actuate the trap 100. This is because left end 208 of the hook 200 is disposed closer to the edge of the open end of the hollow channel 184. Thus, in a horizontal orientation, even the weight of a mouse can trip the trap to close. As the distal free end 185 of the trip member 180 is raised while the trip member 180 is still frictionally engaged to the hook 200, the force required to trip it becomes greater. This is because the left end 208 of the hook 200 is disposed deeper in the hollow channel 184; or stated another way, the left end 208 of the hook 200 is disposed further from the edge of the open end of the hollow channel 184, rendering the trip member 180 less sensitive to weight. In this position the raised position of the trip member 180 (as shown in FIG. 2) is suitable for trapping a snake (of a type which is heavier than a mouse).

In use, the snake trap system 100 is set to catch a mouse, using any suitable bait material such as peanut butter placed on the distal end 185 of the trip member 180. When the mouse trips the snake trap system 100 the mouse is trapped. The mouse is removed, as discussed below, by the live bait transporter 260 and later used as bait in the center of the lower trap portion 120 of the snake trap system 100.

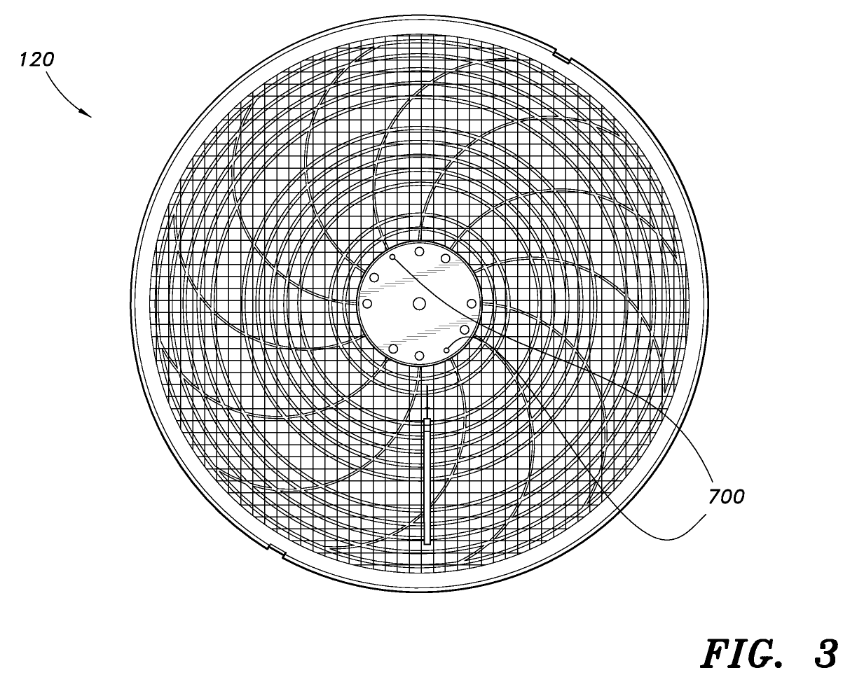

FIG. 3 is a bottom elevational view of the lower trap portion 120 of FIG. 1. A pair of bores 700 is shown. The lowermost arm portions of the guide member 400 pass through the bores 700 and are fixedly secured to the lower trap portion 120 by nuts; alternatively, they can be fixed by welding, or glue.

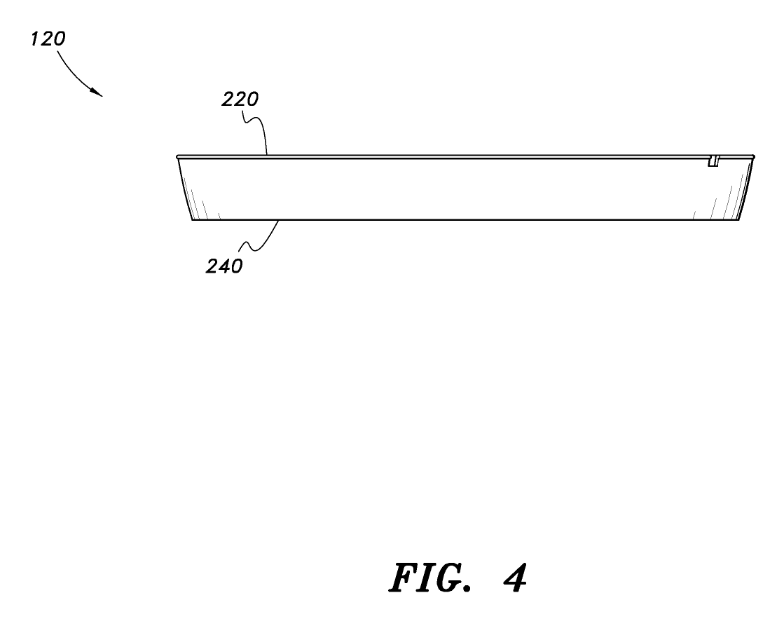

FIG. 4 is a side elevational view of the lower trap portion 120 of FIG. 1, showing a top edge 220 and a bottom side 240.

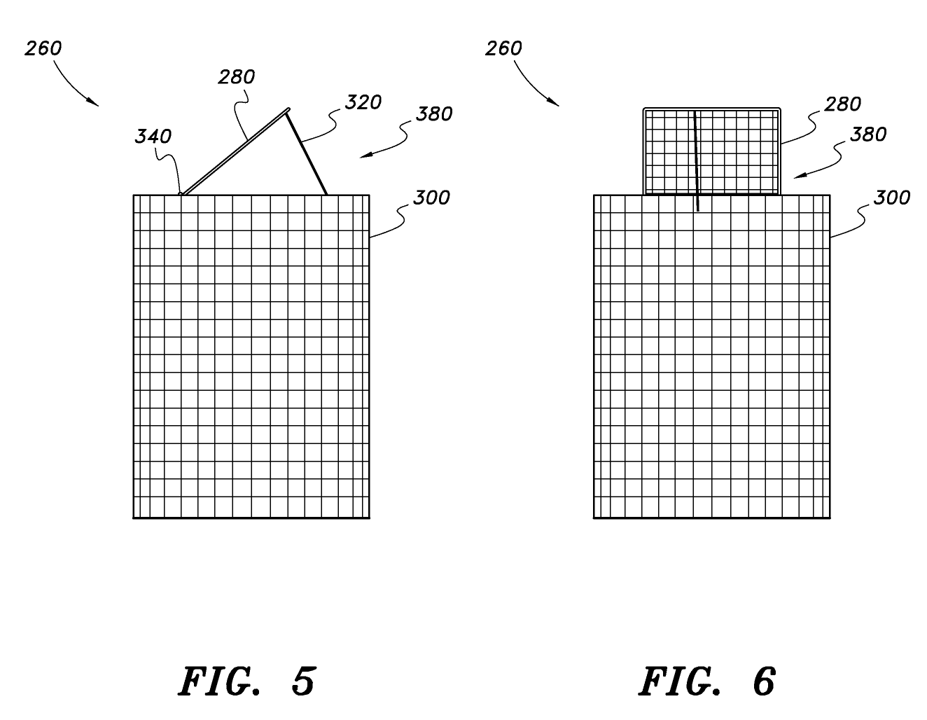

FIG. 5 is side elevational view of the live bait transporter 260 used in the snake trap system 100. The transporter 260 includes a wire mesh cage body portion 300, a hinged door 280, a hinge 340, and a trip member 320 which can be used either to prop open the door 280 or as a handle for manually opening the door 280. The hinged door 280 is preferably spring-biased toward a closed position; alternatively, the opening and closing of the door 280 may be done manually.

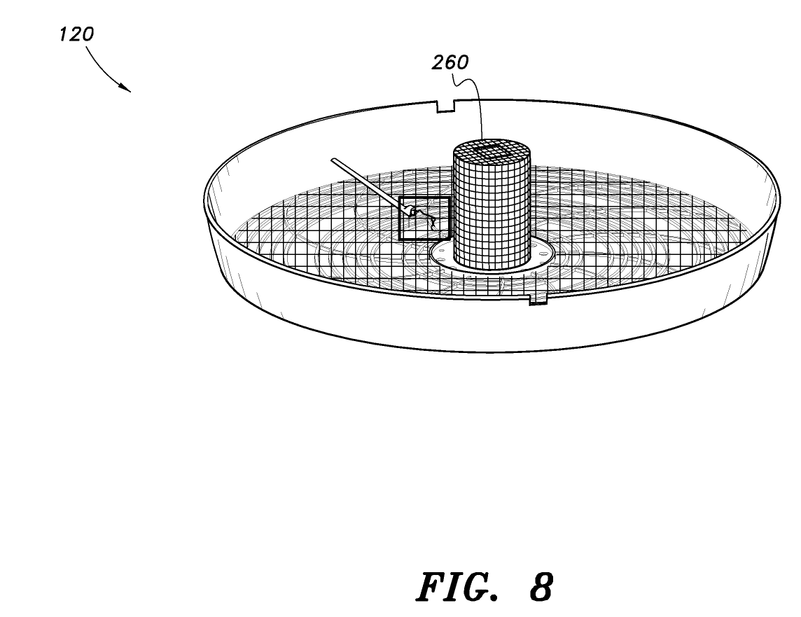

When the mouse is trapped inside the snake trap system 100, the live bait transporter 260 is secured to the opening 800 (shown in FIG. 11) formed in the side of the upper trap portion 360 with the door 280 propped open, so that the mouse will enter. The slideable clamp 720 is used to engage a mesh doorway 262 (see FIG. 7) of the live bait transporter 260, while teeth 760 (shown in FIG. 11A) engage the opposite side of the transporter doorway 262, thus holding the transporter 260 in place over the opening 800.

Once the live bait transporter 260 is secured over the doorway 800, the live bait transporter 260 is covered with a dark cloth to provide a safe-looking environment for the mouse. In addition, some bait, such as peanut butter, can be placed inside the live bait transporter 260 to draw the mouse into the live bait transporter 260.

When the mouse enters the live bait transporter 260, it is removed from the snake trap system 100 and the door 280 is closed. The transporter, with the mouse inside, can then be placed in the interior of the snake trap system 100 when it is in the open position “A” of FIG. 20. The trip member 180 is then set for the weight of a snake as discussed hereinabove, and the scent of the mouse then attracts a snake into the trap.

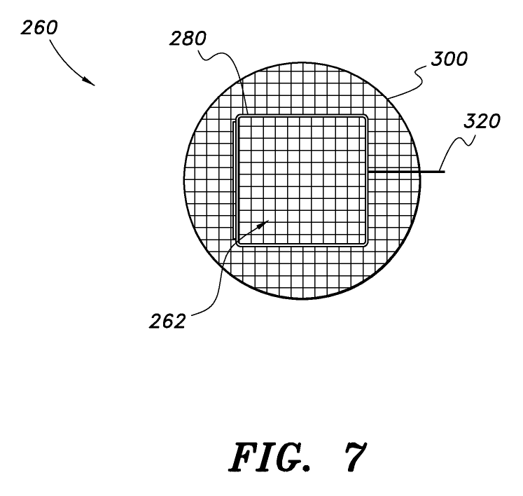

FIG. 6 is a side elevational view of the transporter 260 of FIG. 5, as viewed from the right of FIG. 5.

FIG. 7 is bottom elevational view of the transporter of FIG. 5.

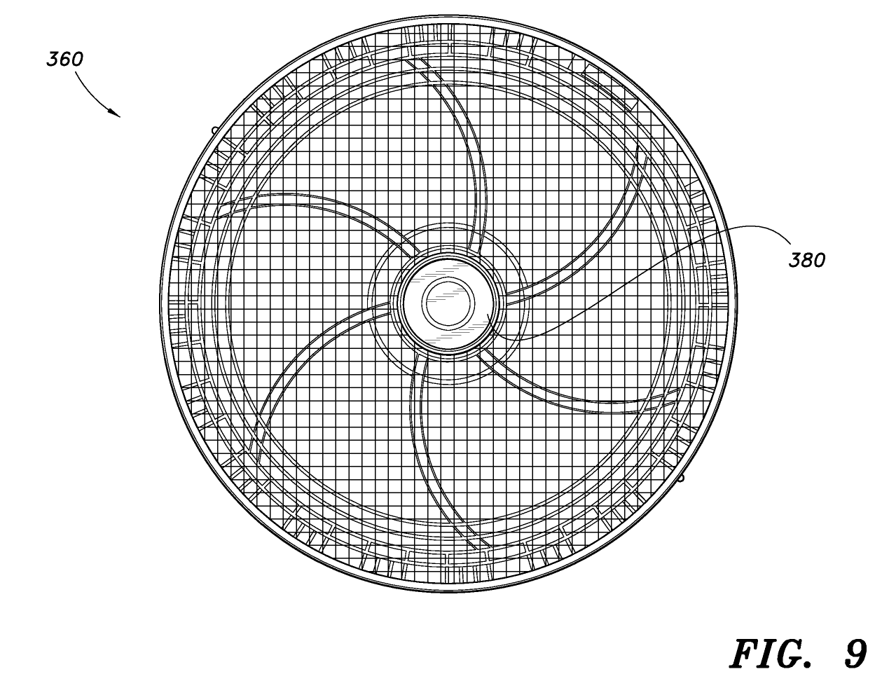

FIG. 8 is a perspective view of the transporter 260 disposed on the lower trap portion 120, in an operational position. Here, if live bait such as a mouse is disposed in the transporter 260, the transporter 260 protects the live bait. The live bait attracts a snake.

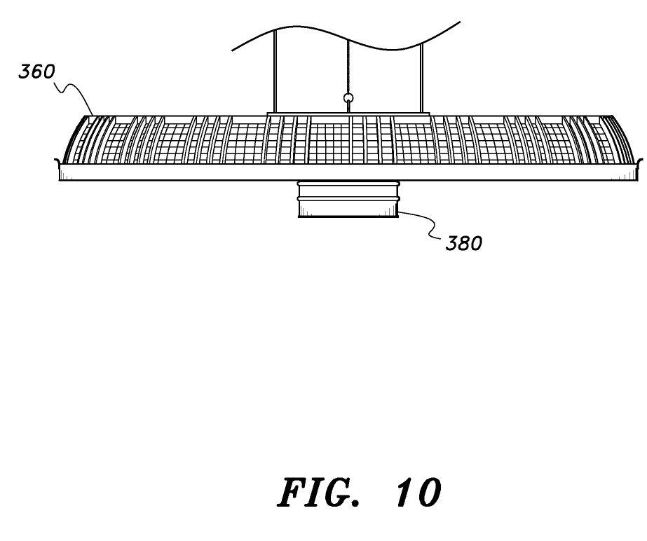

FIG. 9 is a bottom elevational view of the upper trap portion 360 used in the snake trap system 100 of the present invention. In this view, the hollow interior of the enclosure member 380 is visible.

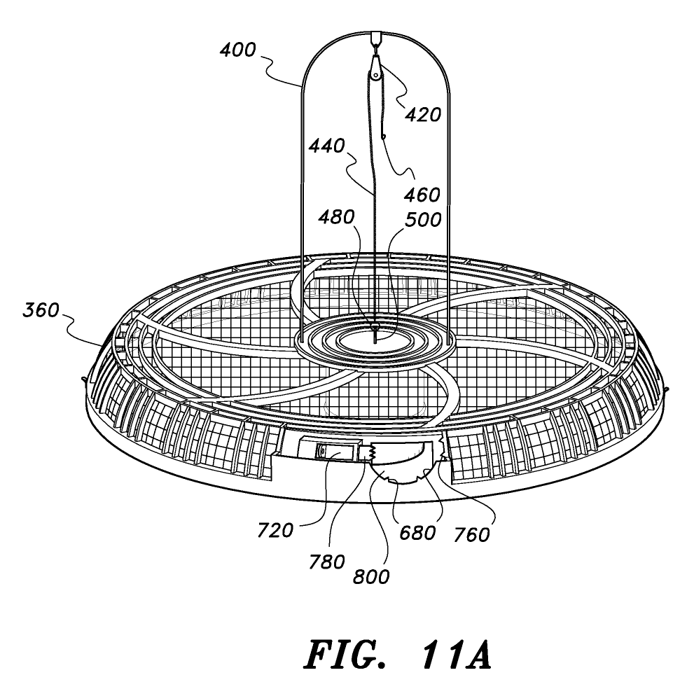

FIG. 10 is a side elevational view of the upper trap portion 360 used in the snake trap system 100, in a raised position showing a lower portion of an enclosure member 380.

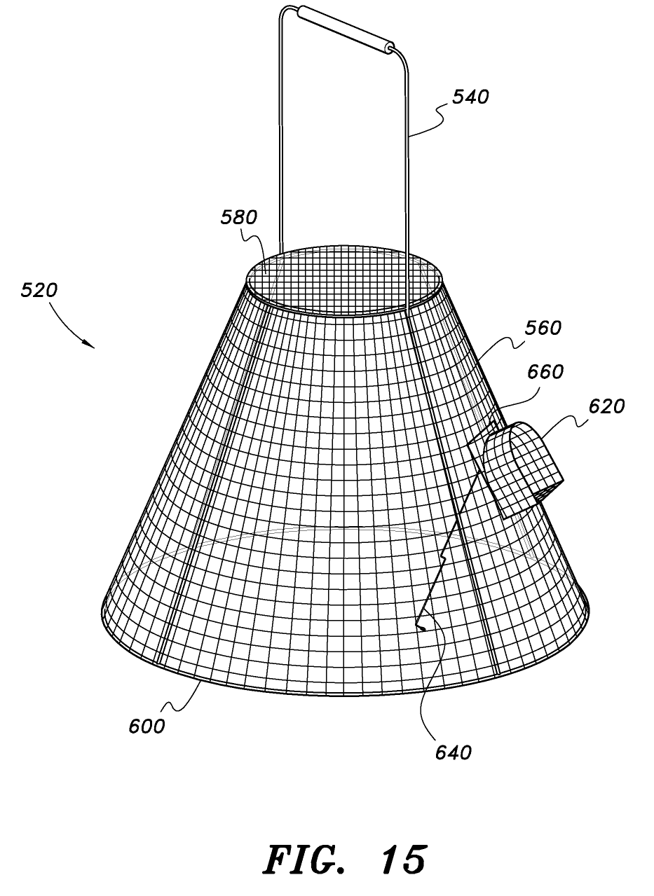

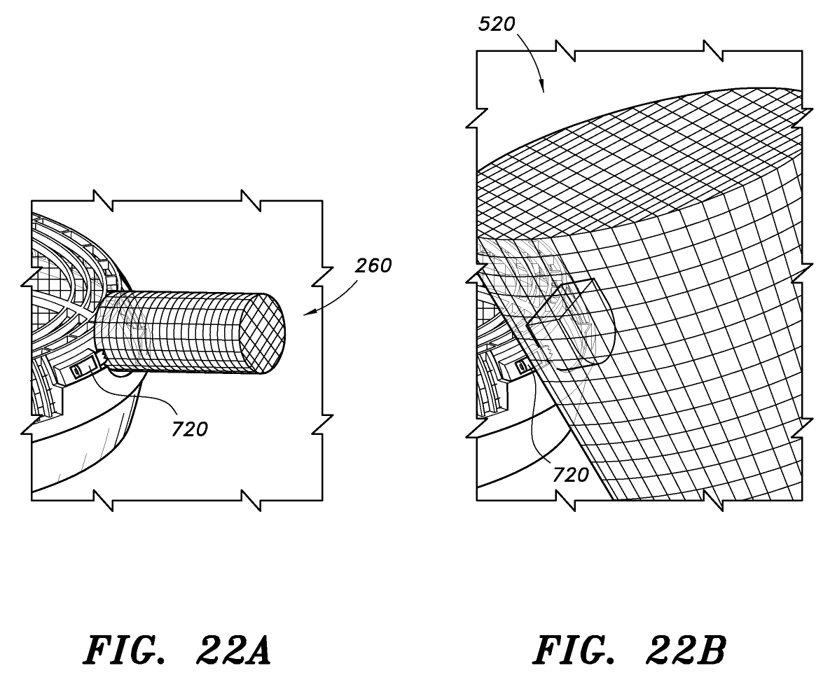

FIGS. 11A and 11B are side views of the upper trap portion 360 of FIG. 10, showing an opening 800 therethrough and also showing a slideable clamp 720 and teeth 760 disposed on either side of opening 800. The slideable clamp 720 and teeth 760 can be used to hold a removeable cover 382 in place over the opening 800 (see FIG. 11C). The cover 382 rests on ledge 680 when secured over the opening 800. Alternatively, the slideable clamp 720 and teeth 760 can be used to clamp the doorway of the live bait transporter or the snake transporter basket 520 (shown in FIG. 15) to the snake trap 100 by gripping the sides of the wire mesh doorway of either the live bait transporter 260 or the snake transporter basket 520, so that the opening of the snake trap 800 is aligned with the opening of either the snake transporter basket 520 or the live bait transporter 260. The slideable clamp 720 is slideable to extend over the cover 382, or engage with the side of the mesh wire doorway of either the snake transporter basket 520 or live bait transporter 260; the clamp 720 has a plurality of teeth (shown in greater detail in FIGS. 22A and 22B). Also, a side of the upper trap portion adjacent to the opening 800 includes teeth 760 (also discussed and shown hereunder with regard to FIGS. 22A and 22B). Together, the slideable clamp 720 and the teeth 760 can clamp an article therebetween, as discussed herein.

With regard to FIGS. 11A and 11B, the guide member 400 is shown supporting a pulley 420, the chain 440, and the hook 460 disposed at the lowermost end 442 of chain 440. The upper trap portion 360 has an eye 480 secured thereto, which anchors the chain 440. In operation, the upper trap portion 360 is raised by sliding it along the guide member 400, which thereby lowers the hook 460 until it can engage with the hook 200 of the lower trap portion 120. The chain 440 is secured to the eye 480 by a ring 500.

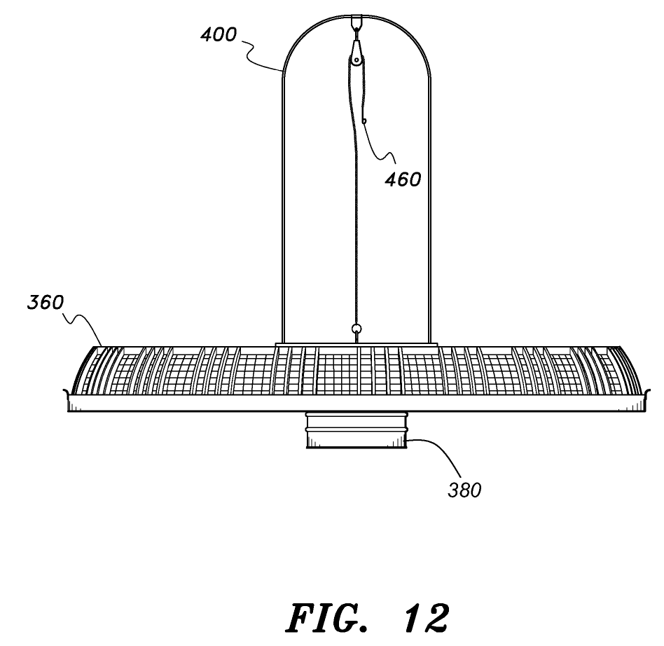

FIG. 12 is a view of the upper trap portion 360 with the enclosure member 380 visible.

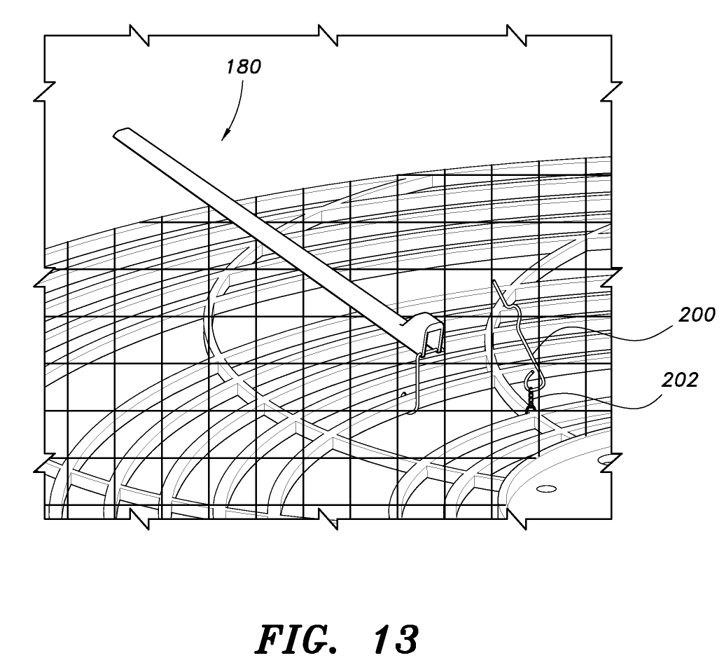

FIG. 13 is an enlarged view of the trip mechanism on the lower trap portion 120, and is similar to FIG. 2 except that the trap has been “tripped” in FIG. 13. The trip mechanism includes the trip member 180, which secures the hook 200 when the hook 200 is tensioned upwardly by a force applied by the chain 440 (shown in, e.g., FIG. 11A). Thus, in the open position “A” of FIG. 20, the chain 440 is able to support the entire weight of the upper trap portion 360.

FIG. 14 is a schematic side view, partly in section, schematically showing the elements of the trip mechanism of FIG. 13. Here, the trip mechanism has just become separated by action of the trip member 180 due to the weight of a snake thereupon. The weight of the snake causes movement of the trip member 180 in the rotational direction “R”, releasing the hook 200 to move in the direction “S”, and thus releasing the hook 460 to move in the direction “T” under the force applied by the weight of the upper trap portion 360. Thus, in this view, the tripping has just occurred, and the upper trap portion 360 is proceeding to start falling downwardly to trap the snake.

FIG. 15 is a side elevational view of a snake removal basket 520 for the system 100 of the present invention. The snake removal basket 520 is shown with a handle 540, a mesh body 560, a top 580, a bottom 600, a doorway 620, and an operating member 640 for operating a hinged door 660. The doorway 620 is secured to the opening 800 of FIG. 11A by the clamping action of the teeth of the slideable clamp 720 and the teeth 760, so that the snake removal basket 520 can be secured in place while removing a snake. By covering the snake removal basket 520 with a cloth, the snake can be lured out of the interior of the snake trap system 100 via the opening 800 and into the interior of the snake removal basket 520.

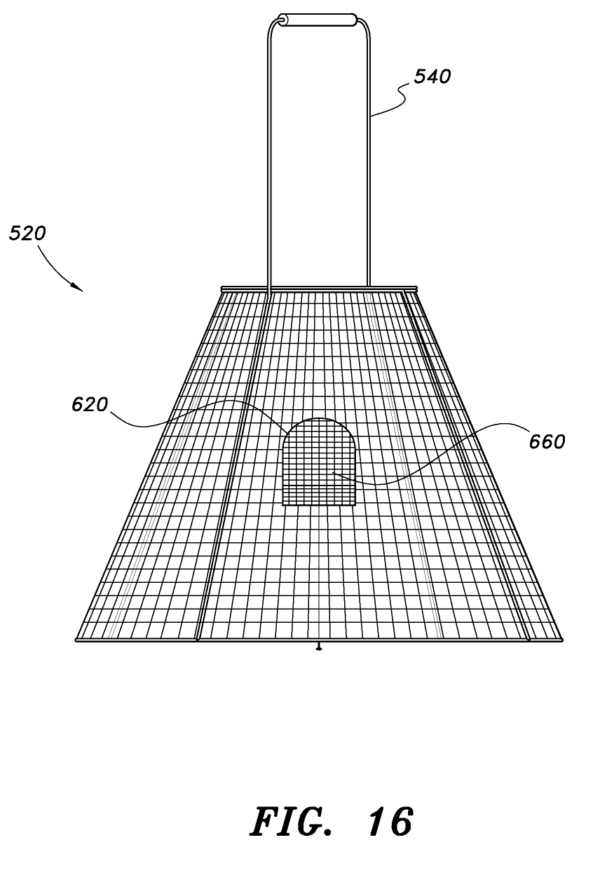

FIG. 16 is a side elevational view of the live bait trap 520 of FIG. 15, as seen from the left of FIG. 15.

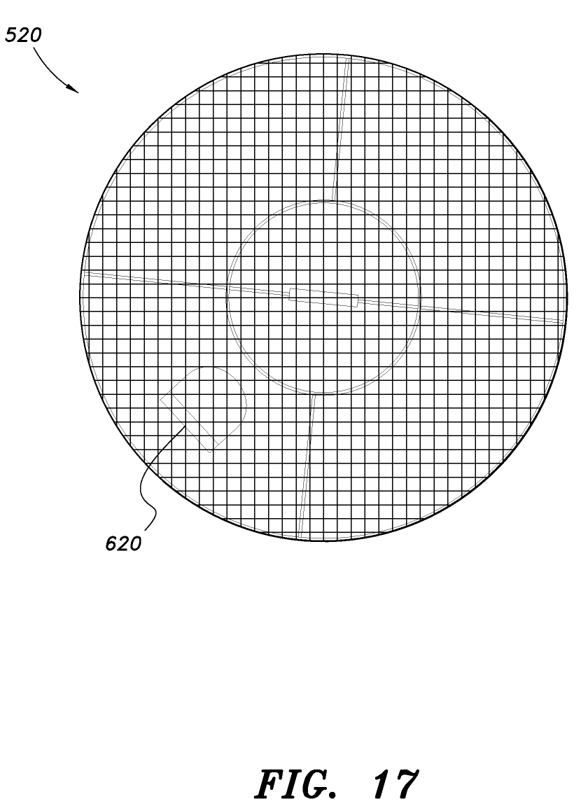

FIG. 17 is a top elevational view of the live bait trap 520 of FIG. 15.

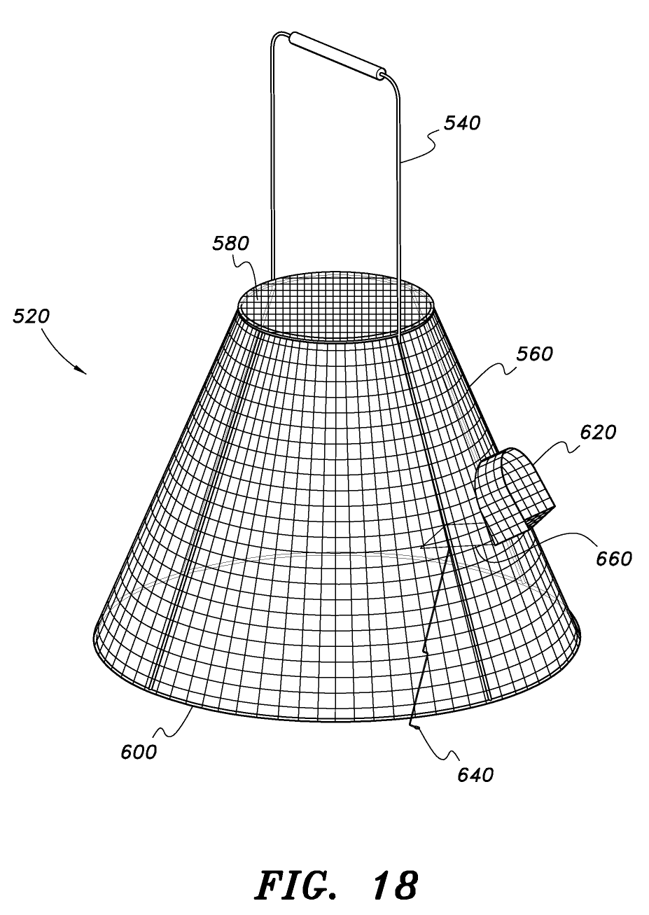

FIG. 18 is an enlarged side elevational view of a doorway portion 620 of the snake removal basket 520 of FIG. 15, showing the door operating member 640 extending through the bottom 600. The hinged door 660 is shown in an open position in this view.

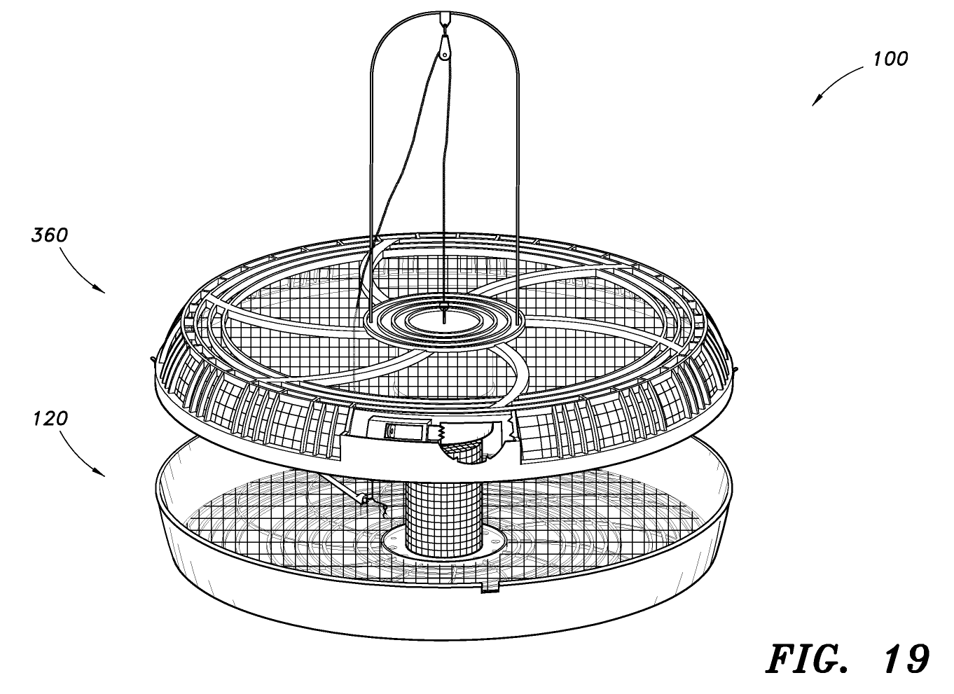

FIG. 19 is a perspective view of the snake trap 100 assembled in an operating position corresponding to position “A” of FIG. 20. In this view, the slideable clamp 720 is shown having teeth 780, and also shows the opening 800 and the adjacent teeth 760.

FIG. 20 is a simplified schematic view of the operation of the snake trap 100 of FIG. 19. This view has been discussed in detail hereinabove.

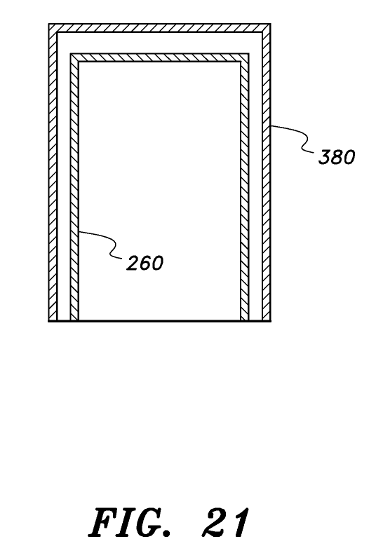

FIG. 21 is a schematic sectional view of the enclosure member 380 in a closed position “B” of the trap 100, in an enclosing position over the transporter 260.

FIGS. 22A and 22B are enlarged, schematic view of the slideable clamp 720 shown in FIG. 19. As seen in FIGS. 22A and 22B, the slideable clamp 720 and teeth 760 can extend over a cover 382, which rests on ledge 680 (see FIG. 11A), to secure it in place over opening 800. The slideable clamp 720 has a plurality of teeth 780, which are schematically illustrated. A recess 740 is disposed in a wall adjacent the opening on the opposite side of the slideable door 720, and a plurality of teeth 760 are disposed in the recess. One purpose of the teeth 760 and 780 is to secure the doorway portion 620 of the snake removal basket 520 of FIG. 15 to the opening 380 so that a trapped snake can enter the snake removal basket 520 and be secured therein. The teeth 760 of and 780 can also be used to secure the doorway portion 280 of live bate transporter 260 of FIG. 6 to the opening 380 so that a trapped mouse can enter the live bait transporter 260 and be secured therein.

The teeth 760 and the teeth 780 can be larger or smaller, or fewer in number, or longer, and all such variations are contemplated as being within the scope of the present invention.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A snake trap system for trapping snakes, comprising:
a lower trap portion having a trip mechanism;
a live bait transporter supported by the lower trap portion;
a guide member secured to the lower trap portion;
an upper trap portion receiving the guide member in sliding engagement therewith;
a pulley member supported by the guide member;
a chain connected to the upper trap portion and having a hook secured to the upper trap portion; and
a hook connected to the chain, adapted for engagement with the trip mechanism of the lower trap portion such that the chain can support the weight of the upper trap portion in an open position of the trap,
whereby release of the trip mechanism by weight of a snake releases the upper trap portion to fall onto the lower trap portion to trap a snake.

2. The snake trap system for trapping snakes of claim 1, further comprising an opening in a side wall of the upper trap portion sufficiently large to enable passage of a snake therethrough; and a slideable clamp which is manually extendible to selectively secure a removeable cover plate over the opening in the side wall of the upper trap portion.

3. The snake trap system for trapping snakes of claim 2, further comprising a recess with teeth disposed on a side of the opening opposite the slideable clamp.

4. The snake trap system for trapping snakes of claim 3, further comprising a ledge formed in the upper trap portion for supporting the removeable cover plate.

5. The snake trap system for trapping snakes of claim 1, wherein the upper trap portion and the lower trap portion are each substantially saucer-shaped.

6. The snake trap system for trapping snakes of claim 1, wherein the transporter is a substantially cylindrical hollow body formed of wire mesh material, having a hinged door at the top thereof and having an elongated rod-like portion for manual operation of the hinged door.

7. A snake trap system for trapping snakes and for removing a trapped snake, comprising:
A snake trap having a lower trap portion having a trip mechanism, the lower trap portion having a central base for supporting the transporter having the live bait therein;
a transporter for transporting captured live bait from the snake trap, and for protecting the live bait when placed inside the snake trap;
the snake trap having a guide member secured to the lower trap portion, an upper trap portion receiving the guide member in sliding engagement therewith, a pulley member supported by the guide member, a chain connected to the upper trap portion and having a hook secured to the upper trap portion, and a hook connected to the chain, adapted for engagement with the trip mechanism of the lower trap portion such that the chain can support the weight of the upper trap portion in an open position of the trap; and
a snake removal basket having a hinged opening for placement of a live snake therein, the opening being adapted to cover an opening in a side wall of the upper trap portion,
whereby release of the trip mechanism by weight of a snake releases the upper trap portion to fall onto the lower trap portion to trap a snake.

8. The snake trap system of claim 7, further comprising a slideable clamp which is manually extendible to selectively secure a removeable cover plate over the opening in the side wall of the upper trap portion.

9. The snake trap system of claim 7, further comprising an opening in a side wall of the upper trap portion sufficiently large to enable passage of a snake therethrough; and a slideable clamp which is manually extendible to selectively secure a removeable cover plate over the opening in the side wall of the upper trap portion.

10. The snake trap system for trapping snakes of claim 7, further comprising a recess with teeth disposed on a side of the opening opposite from the door when the door is in an open position.

11. The snake trap system for trapping snakes of claim 7, further comprising a ledge formed in the upper trap portion for supporting the removeable cover plate.

12. The snake trap system for trapping snakes of claim 7, wherein the upper trap portion and the lower trap portion are each substantially saucer-shaped.

13. The snake trap system for trapping snakes of claim 7, wherein the transporter is a substantially cylindrical hollow body formed of wire mesh material, having a hinged door at the top thereof and having an elongated rod-like portion for manual operation of the hinged door.
